(19) United States
(12) Patent Application Publication
(10) Pub. No.: US 2016/0311243 A1
(43) Pub. Date: Oct. 27, 2016

(54) MEMBER MANUFACTURING METHOD, MEMBER MANUFACTURING DEVICE, AND MEMBER

(71) Applicant: Jun SAKAMOTO, Osaka (JP)

(72) Inventor: Koji SAKAMOTO, Osaka-shi (JP)

(73) Assignee: Jun SAKAMOTO, Osaka (JP)

(21) Appl. No.: 15/106,021

(22) PCT Filed: Dec. 22, 2014
(86) PCT No.: PCT/JP2014/083918

§ 371 Date: Jun. 17, 2016

(30) Foreign Application Priority Data
Dec. 20, 2013 (JP) 2013-264055

(51) Int. Cl. B41N 1/16; B41C 1/06

(52) U.S. Cl. CPC B41N 1/16; B41C 1/06

(57) ABSTRACT

A member manufacturing method manufactures a member (19) from a transfer target (17) by transferring ink (I) to the transfer target (17). The member manufacturing method includes: a process (S1) and a process (S3). In process (S1), the ink (I) is shifted from a printing plate (3) to a transfer member (5). In process (S3), the transfer member (5) is pressed against the transfer target (17), and a side surface (E) of the transfer target (17) is covered with the elastically deformed transfer member (5). The transfer member (5) includes an elastic body. On the printing plate (3), a pattern (21a) to which the ink (I) adheres is formed. The pattern (21 a) is formed in a manner such that the ink (I) shifted from the pattern (21a) to the transfer member (5) covers all or part of the side surface (E) of the transfer target (17).

### TECHNICAL FIELD

The present invention relates to a member manufacturing method and a member manufacturing device for manufacturing a member from a transfer target by transferring ink to the transfer target, and to a member.

### BACKGROUND ART

There is disclosed in Patent Literature 1 a glass substrate for protecting a liquid crystal display. The glass substrate is arranged on a side closer to a viewer than the liquid crystal display. An anti-reflection coating is formed on a main surface of the glass substrate by an offset printing method. There is no need of forming the anti-reflection coating on a side surface (end surface) of the glass substrate, and thus the anti-reflection coating is not formed on the side surface.

### CITATION LIST

### Patent Literature

### Patent Literature 1

Japanese Patent Application Laid-Open Publication No. 2012-150418

However, there are demands for forming a coating on the side surface of the glass substrate. There are also demands for forming a coating on a side surface of not only a plate-shaped member such as the glass substrate but also various members.

On the other hand, the offset printing method is a printing method of shifting ink from a printing plate to a transfer member and transferring the ink from the transfer member to a transfer target (to-be-printed object). That is, the offset printing method is a printing method of performing printing via an intermediate (transfer member).

More specifically, a shape of the transfer member is cylindrical, and the ink transfer is performed by making a circumferential surface of the transfer member in contact with the main surface of the transfer target. Therefore, the offset printing method is originally not intended to form the coating on the side surface of the transfer target.

### SUMMARY OF INVENTION

### Technical Problem

The inventor of the present application has found a new object to form a coating on the side surface of the transfer target based on the offset printing method, that is, via the intermediate.

In view of the object described above, the present invention has been made, and it is an object of the present invention to provide a member manufacturing method and a member manufacturing device capable of manufacturing a member from a transfer target by easily forming a coating on a side surface of the transfer target via an intermediate, and a member.

### Solution to Problem

According to a first aspect of the present invention, a member manufacturing method manufactures a member from a transfer target by transferring ink to the transfer target. The member manufacturing method includes: shifting the ink from a printing plate to a transfer member; and pressing the transfer member against the transfer target and covering a side surface of the transfer target with the elastically deformed transfer member.

In the member manufacturing method of the present invention, it is preferable that the transfer member include an elastic body.

In the member manufacturing method of the present invention, it is preferable that, on the printing plate, a pattern to which the ink adheres be formed. It is preferable that the pattern be formed in a manner such that the ink shifted from the pattern to the transfer member covers all or part of the side surface of the transfer target.

In the member manufacturing method of the present invention, it is preferable that a shape of the pattern be linear.

Alternatively, in the member manufacturing method of the present invention, it is preferable that the pattern has a flame shape.

In the member manufacturing method of the present invention, it is preferable that the pattern be formed in a manner such that the ink shifted from the pattern to the transfer member covers a main surface of the transfer target.

In the member manufacturing method of the present invention, it is preferable that a shape of the pattern be rectangular.

In the member manufacturing method of the present invention, it is preferable that the transfer member include a blanket. It is preferable that rubber Shore hardness of the blanket be at least 20 and no greater than 30 or at least 1 and no greater than 5 depending on a thickness of the transfer target.

According to a second aspect of the present invention, a member manufacturing device manufactures a member from a transfer target by transferring ink to the transfer target. The member manufacturing device includes: a printing plate and a transfer member. To the printing plate, the ink is supplied. To the transfer member, the ink is shifted from the printing plate. The transfer member is pressed against the transfer target and elastically deformed to cover a side surface of the transfer target.

It is preferable that the member manufacturing device of the present invention further include an impression cylinder. It is preferable that the transfer member and the impression cylinder sandwich the transfer target.

According to a third aspect of the present invention, a member includes: a transfer target; and a coating. The coating covers a side surface of the transfer target. The coating is formed of ink transferred from a transfer member to the side surface. The ink is transferred by covering the side surface with the transfer member through elastic deformation of the transfer member.

### Advantageous Effects of Invention

According to the present invention, ink can easily be transferred to a side surface of a transfer target by covering the side surface of the transfer target with an elastically deformed transfer member (intermediate). As a result, a coating is formed on the side surface of the transfer target by the ink, thereby manufacturing a member from the transfer target.

### BRIEF DESCRIPTION OF DRAWINGS

FIG. 1A is a side view schematically showing an offset printing device (member manufacturing device) according to a first embodiment of the present invention.

FIG. 1B is a perspective view showing a transfer target and a member of FIG. 1A.

FIG. 2A is a perspective view showing a mechanism in which ink is transferred to a side surface (a side surface orthogonal to a conveyance direction) of the transfer target by the offset printing device of FIG. 1A.

FIG. 2B is a sectional view taken along line IIB-IIB of FIG. 2A.

FIG. 3A is a perspective view showing a mechanism in which the ink is transferred to a side surface (a side surface parallel to the conveyance direction) of the transfer target by the offset printing device of FIG. 1A.

FIG. 3B is a sectional view taken along line IIIB-IIIB of FIG. 3A.

FIG. 4A is a perspective view showing a printing plate of FIG. 1A.

FIG. 4B is a development diagram of the plate of FIG. 4A.

FIG. 5A is a development diagram showing a first modified example of the plate of FIG. 1A.

FIG. 5B is a development diagram showing a second modified example of the plate of FIG. 1A.

FIG. 5C is a development diagram showing a third modified example of the plate of FIG. 1A.

FIG. 6A is a perspective view showing a mechanism in which the ink is transferred to one side surface (the side surface parallel to the conveyance direction) of the transfer target by the offset printing device of FIG. 1A.

FIG. 6B is a sectional view taken along line VIB-VIB of FIG. 6.

FIG. 7A is a sectional view showing a mechanism in which the ink is transferred to the side surface (the side surface orthogonal to the conveyance direction) of the transfer target of FIG. 1A in a case where the side surface is concavely curved.

FIG. 7B is a sectional view showing a mechanism in which the ink is transferred to the side surface (the side surface parallel to the conveyance direction) of the transfer target of FIG. 1A in a case where the side surface is convexly curved.

FIG. 8 is a flowchart showing an offset printing method (member manufacturing method) according to a second embodiment the present invention.

FIG. 9 is a sectional view schematically showing an offset printing device (member manufacturing method) according to a third embodiment of the present invention.

FIG. 10A is a perspective view showing a mechanism in which the ink is transferred to a side surface of a columnar transfer target by an offset printing device according to a fourth embodiment of the present invention.

FIG. 10B is a sectional view taken along line XB-XB of FIG. 10A.

FIG. 11A is a perspective view showing a mechanism in which the ink is transferred on to a side surface of a bottle-shaped transfer target by the offset printing device according to the fourth embodiment of the present invention;

FIG. 11B is a sectional view taken along line XIB-XIB of FIG. 11A.

FIG. 12A is a schematic diagram showing a transfer member according to one embodiment of the present invention.

FIG. 12B is a schematic enlarged view of a recessed part formation region shown in FIG. 12A.

FIG. 12C is a schematic sectional view taken along line XIIC-XIIC of FIG. 12B

### DESCRIPTION OF EMBODIMENTS

Hereinafter, the embodiments of the present invention will be described with reference to the drawings. Note that in the drawings, the same or corresponding portions are provided with the same reference numerals and their description will not be repeated.

### First Embodiment

### [Basic Principles]

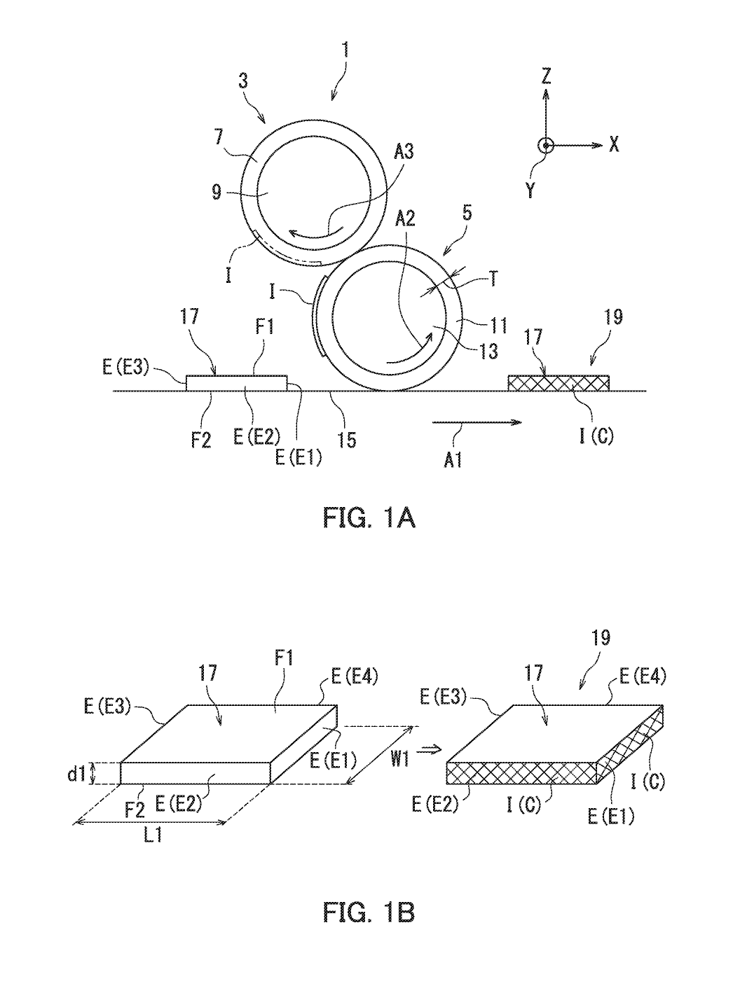

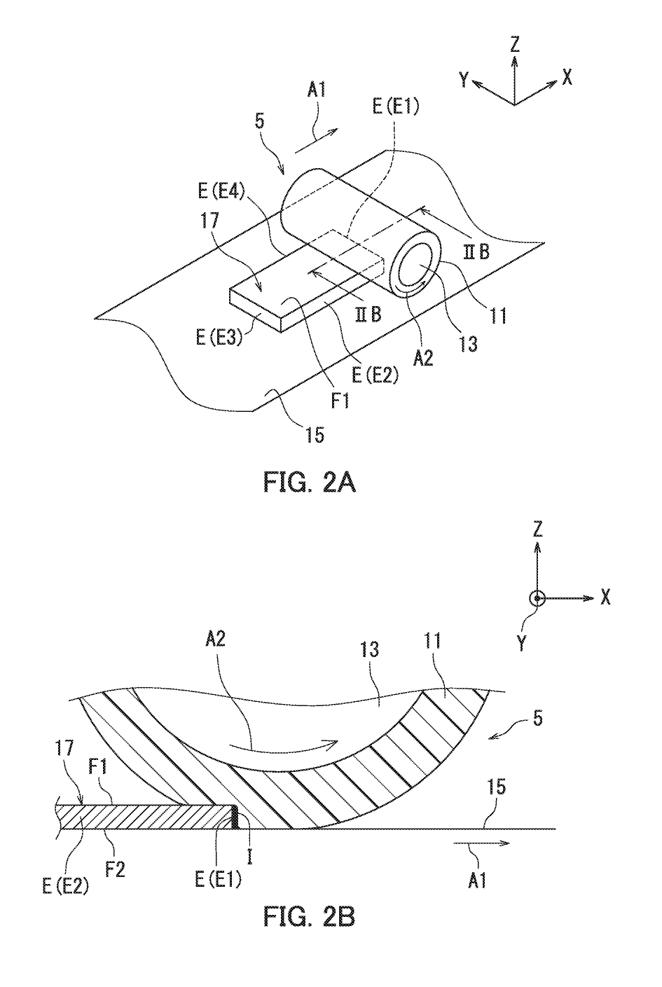

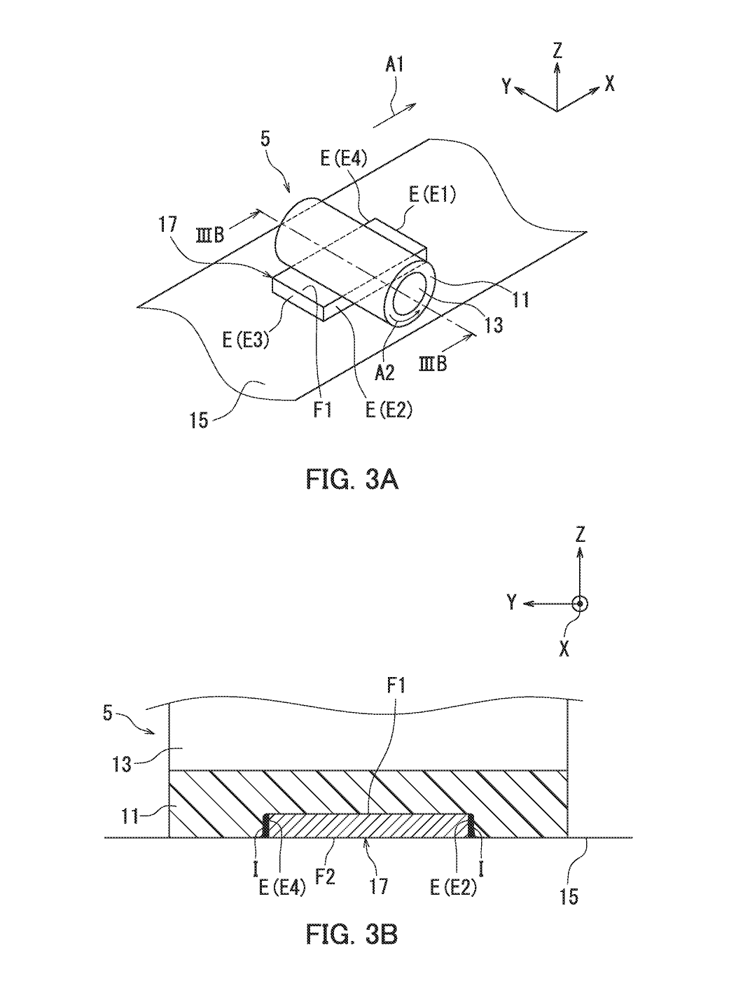

With reference to FIGS. 1A, 1B, 2A, 2B, 3A, and 3B, the basic principles of an offset printing device 1 according to the first embodiment of the present invention will be described. FIG. 1A is a side view schematically showing the offset printing device 1. FIG. 1B is a perspective view showing a transfer target 17 and a member 19 manufactured from the transfer target 17. FIG. 2A is a perspective view showing a mechanism in which ink I is transferred to a side surface E (a side surface E1) of the transfer target 17. FIG. 2B is a sectional view taken along line IIB-IIB of FIG. 2A. FIG. 3A is a perspective view showing a mechanism in which the ink I is transferred to side surfaces E (a side surface E2 and a side surface E4) of the transfer target 17. FIG.3B is a sectional view taken along line IIIB-IIIB of FIG. 3A.

The offset printing device 1 functions as a member manufacturing device. The offset printing device 1 manufactures the member 19 from the transfer target 17 by transferring the ink I to the transfer target 17. The offset printing device 1 includes a printing plate 3 and a transfer member 5. To the printing plate 3, the ink I is supplied. To the transfer member 5, the ink I is shifted from the printing plate 3. The transfer member 5 is pressed against the transfer target 17 and elastically deformed to cover the side surface E of the transfer target 17. For example, the transfer member 5 is pressed against the transfer target 17 along a direction perpendicular to a main surface F1 of the transfer target 17 and elastically deformed to cover the side surface E of the transfer target 17. As a result, the ink I is transferred to the side surface E of the transfer target 17, and a coating (layer) c is formed of the ink I.

According to the first embodiment, through the covering of the side surface E of the transfer target 17 with the elastically deformed transfer member 5 (intermediate), the ink I can be easily transferred to the side surface E of the transfer target 17. As a result, the coating C is formed on the side surface E of the transfer target 17 by the ink I, and from the transfer target 17, the member 19 can be manufactured. Note that in the present specification, the side surface E includes a corner region or a curved region where the side surface E and the main surface F1 intersect each other. However, the side surface E does not have to include the corner region and the curved region.

Hereinafter, in the first embodiment, unless otherwise specified, a plate-shaped transfer target will be described as an example of the transfer target 17, and a plate-shaped member will be described as an example of the member 19. The transfer target 17 and the member 19 are, for example, glass plates. Moreover, unless otherwise specified, as an example of the side surface E of the transfer target 17, an end surface of the plate-shaped transfer target 17 will be described. Hereinafter, the side surface E will be described as the end surface E.

### [Conveyance and Arrangement]

With reference to FIGS. 1A and 1B, the conveyance of the transfer target 17 and the arrangement of the printing plate 3, the transfer member 5, and the transfer target 17 will be described based on a three-dimensional coordinate system. In the first embodiment, a Z-axis extends vertically. X-axis and Y-axis are parallel to a horizontal plane. The offset printing device 1 may further include a conveyance section 15. The conveyance section 15 is, for example, a conveyer belt. The conveyance section 15 extends along the X-axis. On the conveyance section 15, the transfer target 17 is loaded. The conveyance section 15 conveys the transfer target 17 in a conveyance direction Al along the X-axis. Note that a direction orthogonal to the conveyance direction Al is along the Y-axis.

A shape of the transfer target 17 is rectangular in the first embodiment. The transfer target 17 has the main surface F1, a main surface F2, an end surface E1, an end surface E2, an end surface E3, and an end surface E4, which are all flat. The main surface F1 is opposite to the main surface F2. The end surface E1 and the end surface E3 are end surfaces corresponding to short sides of the transfer target 17, and are orthogonal to the conveyance direction Al. The end surface E2 and the end surface E4 are end surfaces corresponding to long sides of the transfer target 17, and are parallel to the conveyance direction A1. The transfer target 17 is loaded on the conveyance section 15 in a manner such that the main surface F1 is oriented perpendicularly to the Z-axis and the end surface E2 is oriented in parallel to the X-axis.

A shape of the printing plate 3 is cylindrical in the first embodiment. The printing plate 3 rotates in a direction of arrow A3 about a cylindrical axis (axial line). The cylindrical axis is along the Y-axis. The printing plate 3 is arranged in a manner such that the cylindrical axis of the printing plate 3 separates furtherer from the conveyance section 15 than a cylindrical axis of the transfer member 5. A circumferential surface of the printing plate 3 makes contact with a circumferential surface of the transfer member 5.

A shape of the transfer member 5 is cylindrical in the first embodiment. The transfer member 5 rotates in a direction of arrow A2 about a cylindrical axis (axial line). The cylindrical axis is along the Y-axis. Therefore, the cylindrical axis of the transfer member 5 and the cylindrical axis of the printing plate 3 are parallel to each other. Moreover, as shown in FIGS. 3A and 3B, a width of the transfer member 5 along the Y-axis is longer than a length W1 (see FIG. 1B) of the short side of the transfer target 17. Then the transfer member 5 is arranged in a manner such that the end surface E2 and the end surface E4 of the transfer target 17 are located between one end edge and another end edge of the transfer member 5.

### [Printing Plate]

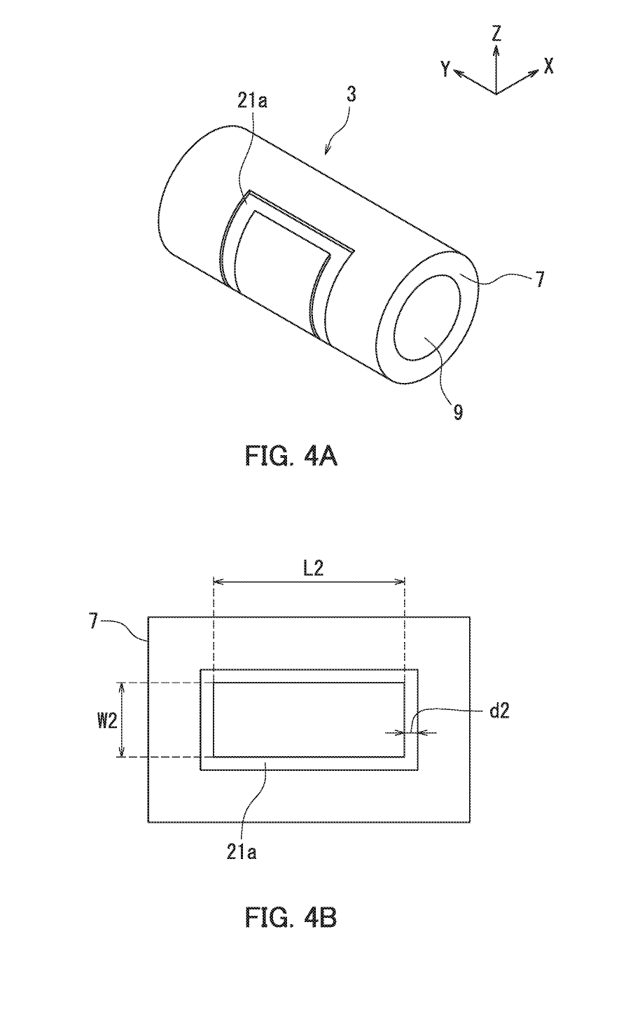

The printing plate 3 will be described in detail with reference to FIGS. 1A, 1B, 4A, and 4B. FIG. 4A is a perspective view showing the printing plate 3. The printing plate 3 includes a plate 7 and a plate cylinder 9. FIG. 4B is a development view of the plate 7. The plate 7 and the printing cylinder 9 are formed of, for example, metal. The metal is, for example, aluminum or iron. A shape of the plate cylinder 9 is cylindrical. The plate 7 is attached to a circumferential surface of the plate cylinder 9. On the plate 7, a pattern 21a of a frame shape is formed. The pattern 21a is a portion of the plate 7 to which the ink I adheres. In the first embodiment, the plate 7 is a recessed plate, and thus the pattern 21a is a recessed part (for example, a groove). Therefore, the offset printing device 1 executes gravure offset printing.

A width d2 of the pattern 21a is almost equal to, for example, a thickness d1 of the transfer target 17 (a thickness of the end surface E). In the first embodiment, the shape of the transfer target 17 is rectangular. Thus, a length L2 of a long side of the pattern 21a forming an inner edge of the pattern 21a is, for example, almost equal to a length L1 of the long side of the transfer target 17. A length W2 of a short side of the pattern 21a forming the inner edge of the pattern 21a is, for example, almost equal to the length W1 of the short side of the transfer target 17. However, the width d2 may be larger than the thickness (the thickness of the end surface E) d1. In this case, the length L2 is smaller than the length L1 and the length W2 is smaller than the length W1. In a configuration in which the width d2 is larger than the thickness d1, the ink I is transferred not only to the end surface E but also to a region along four sides of the main surface F1, and the coating C is formed.

To a circumferential surface of the plate 7 of the printing plate 3 in rotation, the ink I is supplied from an ink supply section (not shown). As a result, the ink I adheres to (is filled in) the pattern 21a.

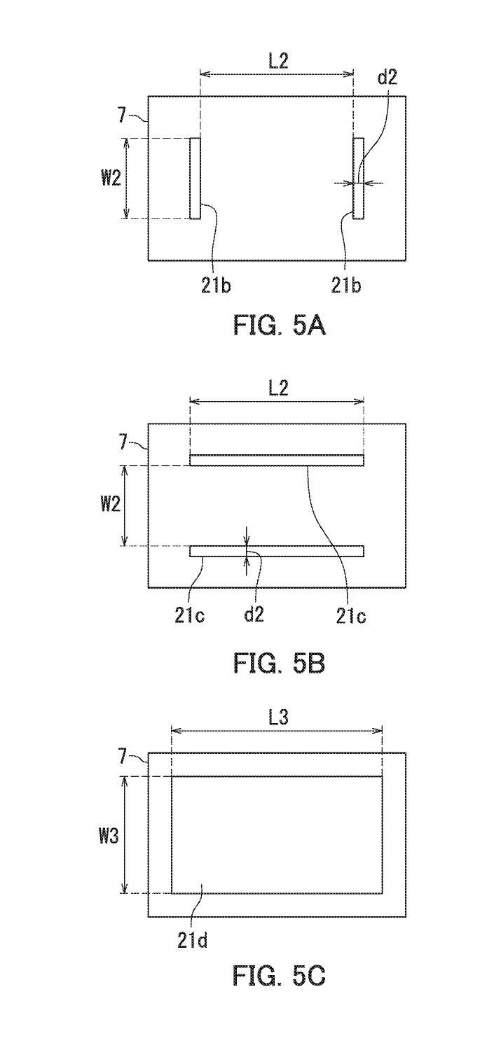

Next, with reference to FIGS. 1A, 1B, 5A, 5B, and 5C, a first modified example, a second modified example, and a third modified example of the plate 7 will be described. FIGS. 5A, 5B, and 5C are development diagrams respectively showing the first modified example, the second modified example, and the third modified example. In the first to third modified examples, each of patterns 21b to 21d is a recessed part. The ink I adheres to the patterns 21b to 21d in the same manner as the ink I adheres to the pattern 21a.

On the plate 7 according to the first modified example, the two linear patterns 21b are formed in correspondence with the end surface E1 and the end surface E3 of the transfer target 17. Therefore, through use of the plate 7 according to the first modified example, the ink I is transferred to the end surface E1 and the end surface E3.

On the plate 7 according to the second modified example, the two linear patterns 21c are formed in correspondence with the end surface E2 and the end surface E4 of the transfer target 17. Therefore, through use of the plate 7 according to the second modified example, the ink I is transferred to the end surface E2 and the end surface E4.

In the first and second modified examples, for example, a width d2, a length L2, and a length W2 are respectively almost equal to the thickness dl, the length L1 of the long side, and the length W1 of the short side of the transfer target 17. Note that, however, the width d2 may be larger than the thickness (the thickness of the end surface) d1. In this case, for example, in the first modified example, the length L2 is smaller than the length L1 and the length W2 is almost equal to the length W1, and in the second modified example, the length L2 is almost equal to the length L1 and the length W2 is smaller than the length W1. In a configuration in which the width d2 is larger than the thickness d1, the ink I is transferred not only to the end surface E but also to the regions of the main surface F1 that are along the sides of the main surface F1, and a coating C is formed.

On the plate 7 according to the third modified example, the pattern 21d of a rectangular shape is formed in correspondence with the main surface F1 and the end surfaces E1 to E4 of the transfer target 17. A length L3 of a long side of the pattern 21d is, for example, almost equal to a length (d1+L1+d1). A length W3 of a short side of the pattern 21d is, for example, almost equal to a length (d1+W1+d1). Therefore, through use of the plate 7 according to the third modified example, the ink I is transferred to the main surface F1 and the end surfaces E1-E4.

### [Transfer Member]

With reference to FIGS. 1A-3B, the transfer member 5 will be described in detail. The transfer member 5 includes a blanket 11 and a blanket cylinder 13. A shape of the blanket cylinder 13 is cylindrical. The blanket cylinder 13 is formed of, for example, metal. The metal is, for example, aluminum or iron. The blanket 11 is attached to a circumferential surface of the blanket cylinder 13. Therefore, the blanket 11 is formed into a cylindrical shape. The blanket 11 is an elastic body. The elastic body is, for example, rubber. The rubber is, for example, silicone rubber.

Hardness and a thickness T of the blanket 11 are determined depending on the thickness dl of the transfer target 17. The larger the thickness dl of the transfer target 17, the smaller the hardness of the blanket 11 and/or the larger the thickness T of the blanket 11. On the other hand, the smaller the thickness dl of the transfer target 17, the greater the hardness of the blanket 11 and/or the smaller the thickness T of the blanket 11. For example, in a case where the thickness dl of the transfer target 17 is 10 mm, it is preferable that the rubber Shore hardness of the blanket 11 be set at least 1 and no greater than 5, and/or the thickness T of the blanket 11 be set at 30 mm. For example, in a case where the thickness dl of the transfer target 17 is 0.7 mm, it is preferable that the rubber Shore hardness of the blanket 11 be set at least 20 and no greater than 30, and/or the thickness T of the blanket 11 be set at 10 mm.

The shift of the ink I from the printing plate 3 to the transfer member 5 will be described. To the blanket 11 of the transfer member 5 in rotation, the ink I adhering to the pattern 21a of the plate 7 is shifted from the printing plate 3 in rotation. A diameter of the transfer member 5 is, for example, almost equal to a diameter of the printing plate 3. Moreover, an angular speed upon the rotation of the transfer member 5 is, for example, almost equal to an angular speed upon the rotation of the printing plate 3.

Next, mechanisms in which the ink I is transferred from the blanket 11 to the end surfaces E of the transfer target 17 will be described in detail. First, with reference to FIGS. 2A and 2B, the mechanism in which the ink I is transferred to the end surface E1 of the end surfaces E will be described. The end surface E1 is a planar surface. The transfer member 5 rotates in the direction of arrow A2. On the other hand, the transfer target 17 is conveyed (along the conveyance direction A1) towards the transfer member 5 with the end surface E1 as a head and the end surface E3 as a tail end. Then the end surface E1 is sandwiched between the blanket 11 and the conveyance section 15. The blanket 11 is being pressed against the transfer target 17, and is thus elastically deformed to cover the end surface E1 of the transfer target 17. As a result, the ink I is transferred from the blanket 11 to the end surface E1 of the transfer target 17.

Next, with reference to FIGS. 3A and 3B, the mechanism in which the ink I is transferred to the end surfaces E2-E4 will be described. The end surfaces E2-E4 are planar surfaces. When the transfer target 17 further moves forward along the conveyance direction Al from a state shown in FIGS. 2A and 2B, the transfer target 17 is sandwiched between the blanket 11 and the conveyance section 15. The blanket 11 is being pressed against the transfer target 17 and is thus elastically deformed to cover the end surface E2 and the end surface E4 of the transfer target 17. As a result, the ink I is transferred to the end surface E2 and the end surface E4 of the transfer target 17. Following the forward movement of the transfer target 17, the ink I is transferred to the entire end surface E2 and end surface E4. Then when the end surface E3 as the tail end is sandwiched between the blanket 11 and the conveyance section 15, as is the case with the end surface E1, the ink I is transferred to the end surface E3.

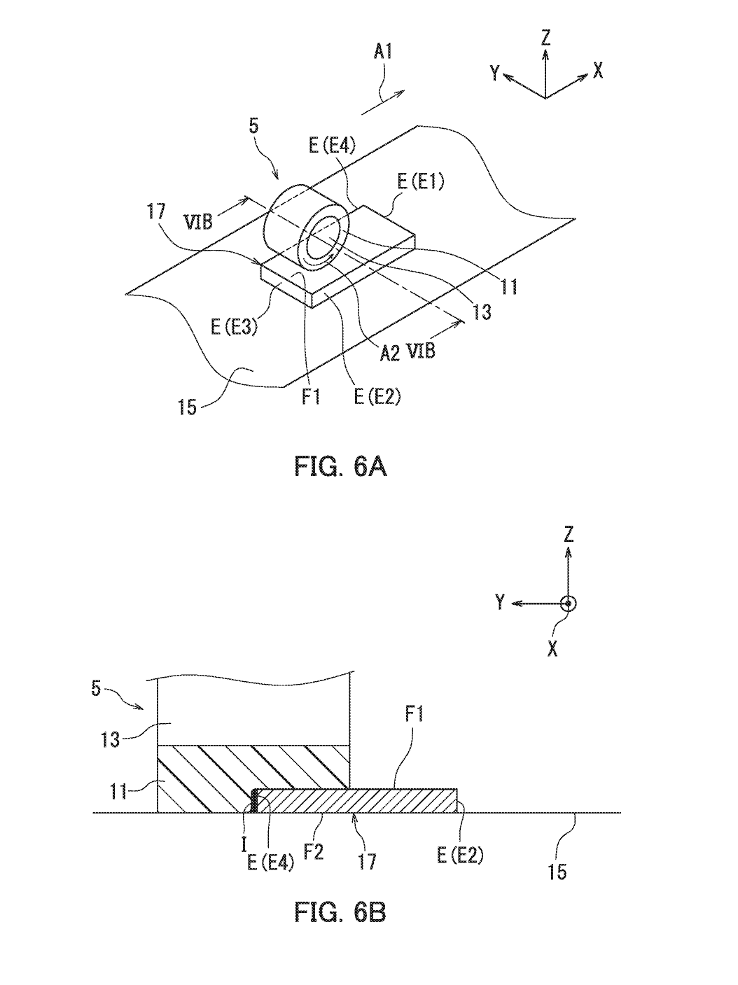

Next, with reference to FIGS. 6A an 6B, an example in which the ink I is transferred to either of a pair of the end surface E2 and the end surface E4 of the transfer target 17 will be described. Hereinafter, the ink I is transferred to the end surface E4. The end surface E4 is a planar surface. FIG. 6A is a perspective view showing the mechanism in which the ink I is transferred to the end surface E4 of the transfer target 17 by the offset printing device 1. FIG. 6B is a sectional view taken along line VIB-VIB of FIG. 6A.

The transfer member 5 is arranged in a manner such that the end surface E4 of the transfer target 17 is located between one end edge and another end edge of the transfer member 5. Note that one end edge of the transfer member 5 is arranged on the main surface Fl, that is, between the end surface E4 and the end surface E2. A width of the transfer member 5 along the Y-axis is almost equal to the length W1 (see FIG. 1B) of the short side of the transfer target 17 or larger than the length W1. Note that, however, the width of the transfer member 5 along the Y-axis may be smaller than the length W1. Moreover, for example, the plate 7 has a linear pattern (recessed part) corresponding to the end surface E4.

When the transfer target 17 moves forward along the conveyance direction A1, the transfer target 17 is sandwiched between the blanket 11 and the conveyance section 15. The blanket 11 is being pressed against the transfer target 17 and is thus elastically deformed to cover the end surface E4 of the transfer target 17. As a result, the ink I is transferred to the end surface E4 of the transfer target 17. Following the forward movement of the transfer target 17, the ink I is transferred to the entire end surface E4.

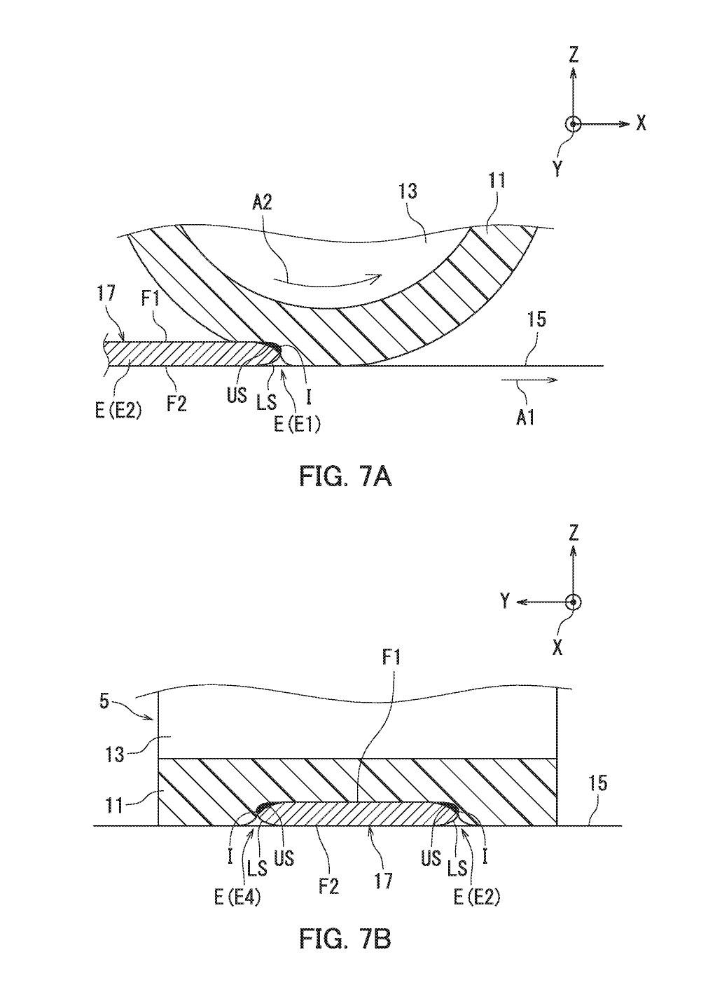

Next, with reference to FIGS. 7A and 7B, transfer of the ink I in a case where the end surface E of the transfer target 17 is convexly curved will be described. For example, a flat end surface E (see FIG. 1) is chamfered to form an end surface E which is convexly curved. FIG. 7A is a sectional view showing the mechanism in which the ink I is transferred to the end surface E1 in a case where the end surface E1 is convexly curved. FIG. 7B is a sectional view showing the mechanism in which the ink I is transferred to the end surface E2 and the end surface E4 in a case where the end surface E2 and the end surface 4 are convexly curved. Each of the end surfaces E1-E4 includes a first inclined surface US and a second inclined surface LS.

When the side surface E1 of the transfer target 17 is sandwiched between the blanket 11 and the conveyance section 15, the blanket 11 is pressed against the transfer target 17 and is thus elastically deformed to cover the first inclined surface US of the end surface E1. As a result, the ink I is transferred from the blanket 11 to the first inclined surface US of the end surface E1. Similarly, when the transfer target 17 is sandwiched between the blanket 11 and the conveyance section 15, the blanket 11 is elastically deformed to cover the respective first inclined surfaces US of the end surface E2 and the end surface E4. As a result, the ink I is transferred from the blanket 11 to the first inclined surfaces US of the end surface E2 and the end surface E4. Moreover, as is the case with the first inclined surface US of the end surface El, the ink I is transferred to the first inclined surface US of the end surface E3.

As the plate 7, for example, the plate 7 shown in FIGS. 4A, 4B, 5A, 5B, and 5C can be used. Note that, for example, respective widths d2 of the patterns 21a to 21c are set at widths sufficient to cover the first inclined surface US. However, the width d2 does not have to be a width exactly covering the first inclined surface US, and may be a width covering, in addition to the first inclined surface US, part of the main surface F1. Moreover, for example, the length L2 and the length W2 of the pattern 21d are set at widths sufficient to cover the main surface F1 and the first inclined surface US.

Moreover, in a situation in which the ink I is transferred not only to the first inclined surface US but also to the second inclined surface LS, the transfer target 17 is flipped over and loaded on the conveyance section 15 in a manner such that the main surface F1 of the transfer target 17 is located at a bottom and the main surface F2 is located at a top. Then the transfer target 17 is conveyed to between the blanket 11 and the conveyance section 15. As a result, as is with a case where the ink I is transferred to the first inclined surface US, the ink I is transferred to the second inclined surface LS. In a situation in which the ink I is transferred to the second inclined surface LS, for example, the same plate 7 as the one used to transfer the ink I to the first inclined surface US is used. For example, through the use of the plate 7 shown in FIG. 5C as the plate 7 for the first inclined surface US and the second inclined surface LS, the ink I can be transferred to the main surface F1, the main surface F2, the first inclined surface US, and the second inclined surface LS of the transfer target 17. As a result, a coating C can be formed on the entire surface of the transfer target 17.

As described above with reference to FIGS. 1A-7B, according to the first embodiment, the coating C can be easily coated on the end surface E of the transfer target 17 via the transfer member 5 (intermediate), thereby manufacturing the member 19 from the transfer target 17.

Moreover, as described with reference to FIGS. 1A and 1B, the coating C is formed on the end surface E in the first embodiment, thereby achieving, for example, reinforcement and/or protection of the end surface E of the transfer target 17 (member 19). Consequently, breakage of the end surface E can be prevented. Dispersion of broken pieces upon the breakage of the end surface E can be also prevented.

For example, in a case where the transfer target 17 (member 19) is a glass plate, the first embodiment in particular is particularly effective. Typically, a small flaw is on an end surface of the glass plate. Therefore, even with slight impact on the end surface, cracking is likely to occur from the small flaw. Then the cracking is enlarged to the main surface of the glass plate, resulting in breakage or chapping of the glass plate. Therefore, in a case where the transfer target 17 is the glass plate, reinforcement and the like of the end surface E of the transfer target 17 (member 19) can be achieved through formation of the coating C on the end surface E by the offset printing device 1 according to the first embodiment, which is useful for suppressing occurrence of the breakage and/or chapping of the glass plate.

For example, the ink I forming the coating C includes a component reinforcing and/or protecting the end surface E. The component of the ink I is, for example, resin. The resin is, for example, photocurable resin or thermosetting resin. The photocurable resin is, for example, radically-curable or cationically-curable. The radically-curable is, for example, acrylic, ene/thiol-based, or vinyl-ether-based. The cationically-curable is, for example, epoxy-based, oxetane-based, or vinyl-ether-based. Moreover, the thermosetting resin is, for example, epoxy-based, phenol-based, or polyester-based. Moreover, a component of the ink I is, for example, a two-liquid mixed type reaction solution.

Further, as described with reference to FIG. 4B, the use of the plate 7 having the pattern 21a can transfer the ink I to the end surface E of the transfer target 17 through one transfer process. Further, as shown in FIG. 5C, the use of the plate 7 having the pattern 21d can transfer the ink I to the main surface F1 in addition to the end surface E of the transfer target 17 through one transfer process. As a result, the coating C can easily be formed on the main surface F1 and the end surface E to reinforce and/or protect the main surface F1 and the end surface E.

Further, as described with reference to FIGS. 3A and 3B, the ink I can be transferred to the two opposing end surfaces E2 and E4 through one transfer process. Moreover, as described with reference to FIGS. 6A and 6B, the ink I can also be transferred to the single end surface E4 through one transfer process. According to the first embodiment, through one transfer process, the ink I can be transferred to the desired end surface E in accordance with its purpose.

### Second Embodiment

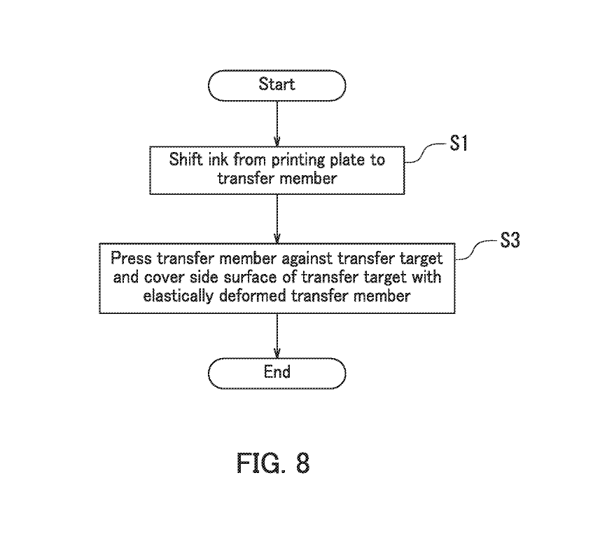

With reference to FIGS. 1A-3B and 8, an offset printing method according to the second embodiment of the present invention will be described. The offset printing method is executed as a member manufacturing method through the use of the offset printing device 1 of the first embodiment described with reference to FIGS. 1A and 1B. FIG. 8 is a flowchart showing the offset printing method. The offset printing method is a method for manufacturing the member 19 from the transfer target 17 by transferring the ink Ito the transfer target 17. The offset printing includes processes S1 and S3.

In process 51, the ink I is shifted from the printing plate 3 to the transfer member 5. In process S3, the transfer member 5 is pressed against the transfer target 17 to cover the side surface E of the transfer target 17 with the elastically deformed transfer member 5. As a result, the ink I is transferred to the side surface E of the transfer target 17, and a coating C is formed of the ink I.

For example, in process S3, the transfer member 5 is pressed against the transfer target 17 along the direction perpendicular to the main surface F1 of the transfer target 17 to cover the side surface E of the transfer target 17 with the elastically deformed transfer member 5. Note that the transfer target 17 and the member 19 have a plate-shaped shape. For example, the transfer target 17 and the member 19 are glass plates. For example, the side surface E of the transfer target 17 is an end surface of the plate-shaped transfer target 17.

According to the present embodiment, the coating C is easily formed on the side surface E of the transfer target 17 via the transfer member 5 (intermediate), thereby manufacturing the member 19 from the transfer target 17.

### Third Embodiment

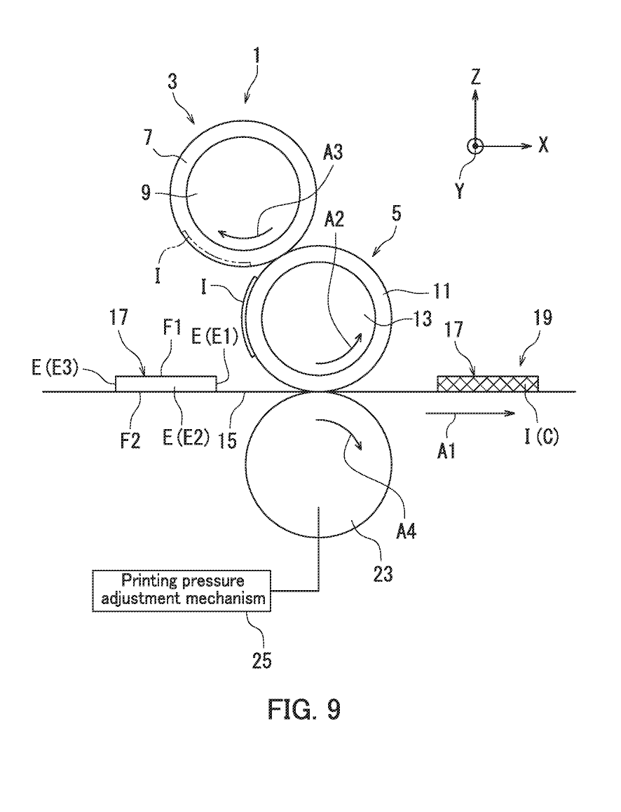

With reference to FIG. 9, an offset printing device 1 according to the third embodiment of the present invention will be described. FIG. 9 is a side view schematically showing the offset printing device 1. The offset printing device 1 includes the printing plate 3, the transfer member 5, an impression cylinder 23, and a printing pressure adjustment mechanism 25.

A shape of the impression cylinder 23 is cylindrical. The impression cylinder 23 rotates in a direction of arrow A4 about a cylindrical axis (axial line). The cylindrical axis is along a Y-axis. A diameter of the impression cylinder 23 is, for example, almost equal to a diameter of the transfer member 5. Moreover, an angular speed of the impression cylinder 23 upon its rotation is, for example, almost equal to an angular speed of the transfer member 5 upon its rotation. The impression cylinder 23 is formed of, for example, metal. The metal is, for example, aluminum or iron.

The transfer member 5 and the impression cylinder 23 sandwich the transfer target 17 on the conveyance section 15. A mechanism in which the ink I is transferred to the side surface E of the transfer target 17 is similar to the mechanisms described with reference to FIGS. 2A, 2B, 3A, 3B, 6A, 6B, 7A, and 7B. Moreover, the offset printing device 1 executes the offset printing method described with reference to FIG. 8.

In the present third embodiment, for example, a position of the transfer member 5 is fixed. The printing pressure adjustment mechanism 25 is connected to the impression cylinder 23 and capable of moving the impression cylinder 23 in a direction bringing the impression cylinder 23 closely to the transfer member 5 and a direction separating the impression cylinder 23 from the transfer member 5. The printing pressure adjustment mechanism 25 moves the impression cylinder 23 to adjust a pressure (hereinafter described as “printing pressure”) for pressing the transfer member 5 against the transfer target 17.

According to the present third embodiment, a coating C can easily be formed on the side surface E of the transfer target 17 via the transfer member 5 (intermediate), thereby manufacturing the member 19 from the transfer target 17.

### Fourth Embodiment

With reference to FIGS. 1A, 1B, 8, 9, 10A, 10B, 11A, and 11B, an offset printing device 1 according to the fourth embodiment of the present invention will be described. Configuration of the offset printing device 1 is equal to the configuration of the offset printing device 1 according to the first embodiment or the configuration of the offset printing device 1 according to the third embodiment. Moreover, an offset printing method executed by the offset printing device 1 is equal to the offset printing method according to the second embodiment. In the present fourth embodiment, the ink I is transferred to the side surface E of not the plate-shaped transfer target 17 but a columnar transfer target 17 or a bottle-shaped transfer target 17.

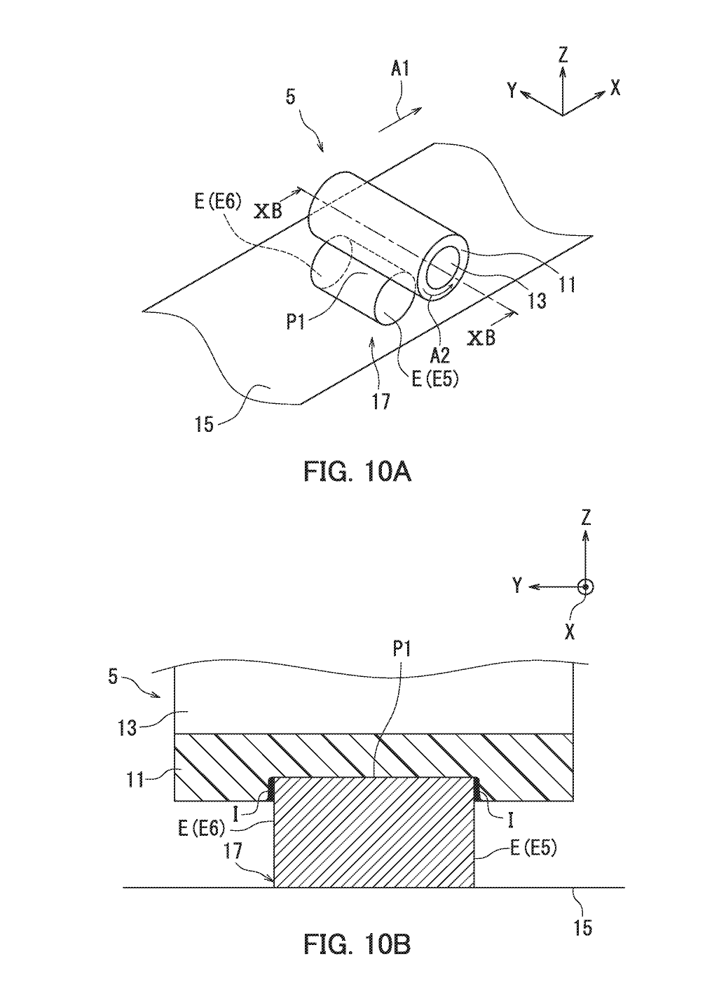

First, with reference to FIGS. 10A and 10B, an example in which the ink I is transferred to the columnar transfer target 17 will be described. FIG. 10A is a perspective view showing a mechanism in which the ink I is transferred to a side surface E5 and a side surface E6 of the columnar transfer target 17. FIG. 10B is a sectional view taken along line XB-XB of FIG. 10A.

The transfer member 5 is arranged in a manner such that the side surface E5 and the side surface E6 of the transfer target 17 are located between one end edge and another end edge of the transfer member 5. Moreover, for example, the plate 7 has the two patterns 21c shown in FIG. 5B.

When the transfer target 17 moves forward along the conveyance direction A1, the transfer target 17 is sandwiched between the blanket 11 and the conveyance section 15. The blanket 11 pressed against a circumferential surface P1 of the transfer target 17 is elastically deformed to cover part of the side surface ES and part of the side surface E6 of the transfer target 17. Further, the transfer target 17 is rotated about an axis of the transfer target 17. As a result, to each of the side surface ES and the side surface E6 of the transfer target 17, the ink I is transferred in an annular form whereby an annular coating is formed.

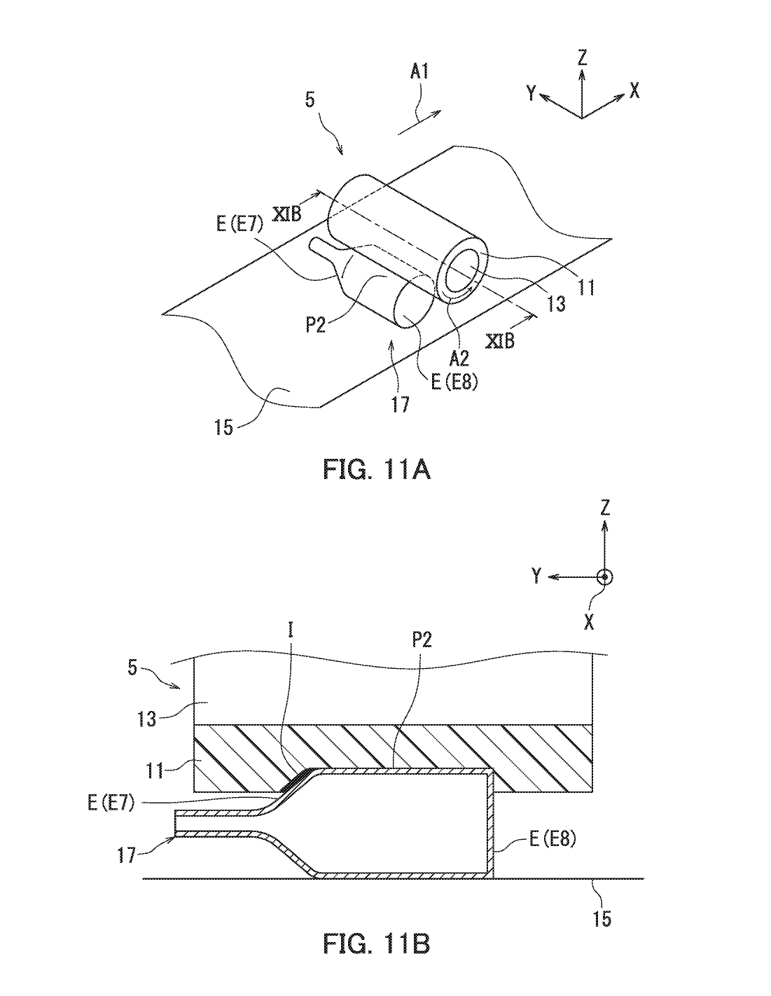

Next, with reference to FIGS. 11A and 11B, an example in which the ink I is transferred to the bottle-shaped transfer target 17 will be described. The transfer target 17 is, for example, a beer bottle. FIG. 11A is a perspective view showing a mechanism in which the ink I is transferred to a side surface E7 of the bottle-shaped transfer member. FIG. 11B is a sectional view taken along line XIB-XIB of FIG. 11A.

The transfer member 5 is arranged in a manner such that the side surface E7 and a side surface E8 of the transfer target 17 are located between one end edge and another end edge of the transfer member 5. The side surface E7 is a shoulder of the transfer target 17, and the side surface E8 is a bottom surface of the transfer target 17. Moreover, for example, the plate 7 has a linear pattern (a recessed part).

When the transfer target 17 moves forward along the conveyance direction Al, the transfer target 17 is sandwiched between the blanket 11 and the conveyance section 15. The blanket 11 pressed against a circumferential surface P2 of a body of the transfer target 17 is elastically deformed to cover part of the side surface E7 of the transfer target 17. Further, the transfer target 17 is rotated about the axis of the transfer target 17. As a result, the ink I is transferred to the side surface E7 of the transfer target 17 in an annular form whereby an annular coating is formed.

According to the present fourth embodiment, the coating C is easily formed on the side surface E of the columnar or bottle-shaped transfer target 17 via the transfer member 5 (intermediate), thereby manufacturing the member 19 from the transfer target 17. It is particularly effective for a glass bottle storing soft drink or alcohol (for example, beer). It is typically known that ultraviolet rays are incident from a shoulder of the bottle to oxidize the stored soft drink or alcohol, leading to quality deterioration. Thus, as shown in FIGS. 11A and 11B, to the side surface E7 (the shoulder of the bottle), the ink I having such a characteristic that absorbs or reflects the ultraviolet rays is transferred to form a coating, which suppresses the quality deterioration.

The embodiments of the present invention have been described above with reference to the drawings (FIGS. 1A-11B). However, the present invention is not limited to the embodiments described above, and it can be carried out in various modes within a range not departing from the spirits of the present invention ((1)-(5)). The drawings each primarily and schematically show each of the components for easier understanding, and the thickness, the length, the quantity, etc. of each component shown are different from those in practice for convenient drawing preparation. Moreover, the shape, dimension, etc. of each component shown in the embodiments described above are each just one example, and the present invention is not limited to them and various modifications can be made thereto within a range not substantially departing from the effects of the present invention.

(1) As the example of the transfer target 17 described with reference to FIGS. 1A and 1B, the glass plate is presented. The glass plate is, for example, a glass plate for a display (for example, a glass plate for a display of a smart phone), or a glass plate for construction. The glass plate for a display is, for example, a glass plat for a touch panel or a glass plate for a liquid crystal display. A material of the transfer target 17 is not limited to glass. For example, its material is synthetic resin or ceramic. Moreover, in FIGS. 1A, 1B, 10A, 10B, 11A, and 11B, the transfer target 17 has a plate shape, a columnar shape, or bottle shape. However, it is not limited to them. For example, its shape is a polyhedron, a cone, a frustum, a column, a solid formed with a curved surface, or a solid formed with a curved surface and a planer surface.

(2) The various patterns 21a to 21d formed on the plate 7 are illustrated with reference to FIGS. 4A, 4B, 5A, and 5B. However, the patterns formed on the plate 7 are not limited to them. The pattern is formed in a manner such that the ink I shifted from the pattern to the transfer member 5 covers a region extending along an edge (for example, a side) of the main surface F1 in addition to all or part of the side surface E of the transfer target 17. The pattern is formed, for example, in a manner such that the ink I shifted from the pattern to the transfer member 5 covers the main surface F1 and all or part of the side surfaces E of the transfer target 17.

(3) In the third embodiment described with reference to FIG. 9, the printing pressure adjustment mechanism 25 moves the impression cylinder 23 to adjust the printing pressure. However, a printing pressure adjustment method is not limited to this. For example, the impression cylinder 23 is fixed. The printing pressure adjustment mechanism 25 is connected to the transfer member 5 and is capable of moving the transfer member 5 in a direction bringing the transfer member 5 closely to the impression cylinder 23 and in a direction separating the transfer member 5 from the impression cylinder 23. The printing pressure adjustment mechanism 25 moves the transfer member 5 to adjust the printing pressure.

(4) As shown in FIGS. 1A and 1B, the member 19 according to one embodiment of the present invention includes the transfer target 17 and the coating C. The coating C covers the side surfaces E of the transfer target 17. The coating C is formed of the ink I transferred from the transfer member 5 to the side surface E by covering the side surface E with the transfer member 5 through elastic deformation of the transfer member 5. In the present embodiment, the coating C is formed on the side surface E, thereby achieving reinforcement and/or protection of the side surface E of the member 19. Consequently, the breakage of the end surface E can be prevented. Moreover, the dispersion of the broken pieces upon the breakage of the end surface E can be prevented.

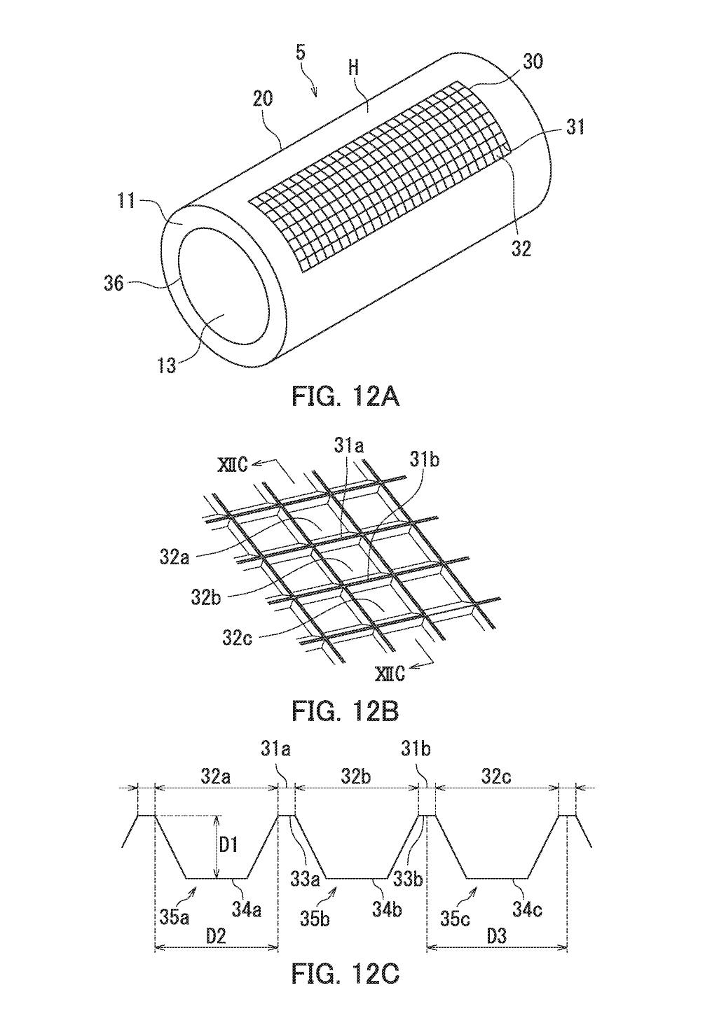

(5) The transfer member 5 described with reference to FIGS. 1A-11A will be described with reference to a detailed example. FIG. 12A is a schematic diagram showing the transfer member 5 according to one embodiment of the present invention. FIG. 12B is a schematic enlarged diagram of a recessed part formation region 30 described in FIG. 12A. FIG. 12C is a schematic sectional view taken along line XIIC-XIIC of FIG. 12B.

With reference to FIG. 12A, the transfer member 5 has the blanket 11 and the blanket cylinder 13. The blanket cylinder 13 has a circumferential surface 36. The blanket 11 is attached to the circumferential surface 36 of the blanket cylinder 13.

On a front surface H of the blanket 11, the recessed part formation region 30 is formed. The recessed part formation region 30 includes a plurality of recessed regions 32 and a plurality of upper regions 31. Each of the plurality of recessed regions defines a recessed part. The plurality of recessed parts are arrayed in a reticular pattern. The upper region 31 connects the plurality of recessed regions 32.

With reference to FIGS. 12B and 12C, the recessed part formation region 30 will be described. The recessed part formation region 30 includes the plurality of recessed regions (a recessed region 32a, a recessed region 32b, and a recessed region 32c) and the plurality of upper regions 31 (an upper region 31a and an upper region 31b). The plurality of recessed regions 32 respectively have recessed parts (a recessed part 35a, a recessed part 35b, and a recessed part 35c). The upper region 31 is defined by the adjacent recessed regions 32. The plurality of recessed parts (the recessed part 35a, the recessed part 35b, and the recessed part 35c) have bottom surface parts (a bottom surface part 34a, a bottom surface part 34b, and a bottom surface part 34c) parallel to upper surface parts (an upper surface part 33a and an upper surface part 33b).

In the recessed part formation region 30, the plurality of recessed regions 32 are larger than the upper regions 31. A ratio occupied by the plurality of recessed regions 32 of the recessed part formation region 30 is, for example, 50-95%. The attachment of the blanket 11 to the blanket cylinder 13 brings the bottom surface parts along the circumferential surface 36. The attachment of the blanket 11 to the blanket cylinder 13 brings the upper surface parts along the circumferential surface 36.

A depth D1 of the plurality of recessed parts 35 is, for example, greater than 0 mm and no greater than 3 mm. Preferably, the depth D1 is at least 0.3 mm and no greater than 0.4 mm. A dimension D2 of the plurality of recessed parts 35 is, for example, at least 30 μm and no greater than 1000 μm. An interval D3 between the plurality of recessed parts is, for example, at least 30 μm and no greater than 1000 μm.

As described above with reference to FIGS. 12A-12C, in the blanket 11 included in the transfer member 5, the plurality of upper regions have the upper surface parts, and the plurality of recessed parts have the bottom surface parts parallel to the upper surface parts. Therefore, the ink I can also be stored in the plurality of recessed parts, thereby increasing the amount of ink I transferrable through one printing trial. As a result, a thick coating can be printed on the transfer target 17 at a time.

Moreover, in the recessed part formation region, the plurality of recessed regions are larger than the upper regions. Therefore, more ink I can be stored in the plurality of recessed parts, as a result of which a thick coating can be printed on the transfer target 17.

### INDUSTRIAL APPLICABILITY

The present invention can be applied to a field in which a process of reinforcing and/or protecting a member is executed and to a member having a side surface.

### REFERENCE SIGNS LIST

1 Offset printing device
3 Printing plate
5 Transfer member
7 Plate
9 Plate cylinder
11 Blanket
13 Blanket cylinder
15 Conveyance section
17 Transfer target
19 Member
21a Pattern
21b Pattern
21c Pattern
21d Pattern
23 Impression cylinder
25 Printing pressure adjustment mechanism
C Coating
E(E1-E8) Side surface
F1 Main surface
F2 Main surface
P1 Circumferential surface
P2 Circumferential surface
I Ink

1. A member manufacturing method manufacturing a member from a transfer target by transferring ink to the transfer target, the member manufacturing method comprising:
shifting the ink from a printing plate to a transfer member; and
rotating the transfer member and covering a side surface of the transfer target with the elastically deformed transfer member.

2. The member manufacturing method according to claim 1, wherein the transfer member includes an elastic body.

3. The member manufacturing method according to claim 1, wherein
on the printing plate, a pattern to which the ink adheres is formed, and
the pattern is formed in a manner such that the ink shifted from the pattern to the transfer member covers all or part of the side surface of the transfer target.

4. The member manufacturing method according to claim 3, wherein
a shape of the pattern is linear.

5. The member manufacturing method according to claim 3, wherein
the pattern has a flame shape.

6. The member manufacturing method according to claim 3, wherein
the pattern is formed in a manner such that the ink shifted from the pattern to the transfer member covers a main surface of the transfer target.

7. The member manufacturing method according to claim 6, wherein
a shape of the pattern is rectangular.

8. The member manufacturing method according to claim 1, wherein
the transfer member includes a blanket, and rubber Shore hardness of the blanket is at least 20 and no greater than 30 or at least 1 and no greater than 5 depending on a thickness of the transfer target.

9. A member manufacturing device manufacturing a member from a transfer target by transferring ink to the transfer target, the member manufacturing device comprising:
a printing plate to which the ink is supplied; and
a transfer member to which the ink is shifted from the printing plate, wherein
the transfer member is rotated and elastically deformed to cover a side surface of the transfer target.

10. The member manufacturing device according to claim 9, further comprising
an impression cylinder, wherein
the transfer member and the impression cylinder sandwich the transfer target.

11. A member comprising:
a transfer target; and
a coating covering a side surface of the transfer target, wherein the coating is formed of ink transferred from a transfer member to the side surface by covering the side surface with the rotated transfer member through elastic deformation of the transfer member.

12. The member manufacturing method according to claim 1, wherein
the transfer member is cylindrical.

13. The member manufacturing device according to claim, wherein
the transfer member is cylindrical.

14. The member according to claim 11, wherein
the transfer member is cylindrical.
